(19) United States
(12) Patent Application Publication
(10) Pub. No.: US 2007/0171378 A1
(43) Pub. Date: Jul. 26, 2007

(54) Automatic dimming heat insulation film

(76) Inventor: Yung-Chung Chen, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/336,771

(22) Filed: Jan. 23, 2006

(51) Int. Cl. G03B 21/00

(52) U.S. Cl. 353/33

(57) ABSTRACT

An automatic dimming heat insulation film includes a substrate, a photosensitive layer, a blocking layer, a protection layer, an adhesive layer, and a stripping layer. The substrate includes a first surface and a second surface. The photosensitive layer made of photosensitive polymer is coated on the first surface of the substrate. The blocking layer containing short-wave blocking agent is coated on the photosensitive layer. The protection layer is coated on the blocking layer. The adhesive layer is coated on the second surface of the substrate. The stripping layer is coated on the adhesive layer.

### BACKGROUND OF THE INVENTION

(a) Field of the Invention

The present invention relates to a heat insulation film, and more particularly, to one that achieves light control results by means of characteristics of special nature or surface, short-wave blocking agent to separate medium high frequency wave, and macromolecular compound nanometer sensitization polymer.

(b) Description of the Prior Art

Various types of heat insulation film sticker generally available in the market can be roughly classified in two types by the way of heat dissipation, surface and reflective. Both types are essentially made of PET as the substrate. For the surface heat dissipation type, on one side of the substrate is processed with several layers of dyestuff in different shades of color. To promote the heat dissipation results, the depth and color of the dyestuff is accented at higher costs and complicated processes. The reflection type is to have the substrate coated with a layer of aluminum reflective film to reflect the light at the expense of poor visibility through the film. The prior art as illustrated in FIG. 6 of the accompanying drawings teaches a heat insulation film composed of hardened epoxy (B1), a substrate (B2), an adhesive layer (B3), and a stripper paper (B4); however, it fails to adjust the vision depending on the intensity of the light. Another type of insulation film of the prior art as illustrated in FIG. 7 composed of photo-catalyst (C1), a substrate (C2), an adhesive layer (C3) and a stripper paper (C4) also fails to adjust the vision of the heat insulation film depending on the intensity of the light.

### SUMMARY OF THE INVENTION

The primary purpose of the present invention is to provide a heat insulation film provided with a blocking layer for automatic adjustment of light. To achieve the purpose, the present invention includes a substrate, a photosensitive layer, a blocking layer, a protection layer, an adhesive layer and a stripping layer. The substrate made of polyester includes a first surface and a second surface. The photosensitive layer made of photosensitive polymer is coated on the first surface of the substrate. The blocking layer covering up the photosensitive layer contains short-wave blocking agent. The protection layer is coated on the blocking layer. The adhesive layer is coated on the second surface of the substrate. The stripping layer is coated on the adhesive layer. Accordingly, while correcting the failure found with the prior art, the present invention provides the following advantages:

1. High privacy behind the heat insulation layer;

2. Not vulnerable to blind angle in vision while allowing easy identification;

3. Automatic adjustment depending on the intensity of the light to reduce danger caused by human errors;

4. Effectively extending service life of the film by separating the short wave band found with the maximal energy through the short-wave blocking agent; and

5. Preventing threatens to human health due to long-term exposure to hazardous energy in the light by separating it from the blocking layer.

### BRIEF DESCRIPTION OF THE DRAWINGS

FIG. 1 is an exploded view of the present invention.

FIG. 2 is a schematic view showing an application of the present invention on the windows of a car.

FIG. 3 is a schematic view showing a status that molecules in the photosensitive layer of the present invention are exposed to light.

FIG. 4 is a schematic view showing a status that molecules in the photosensitive layer of the present invention are not exposed to light.

FIG. 5 is a schematic view showing another application of the present invention on the windows of a home unit.

FIG. 6 is a schematic view showing a heat insulation film of the prior art.

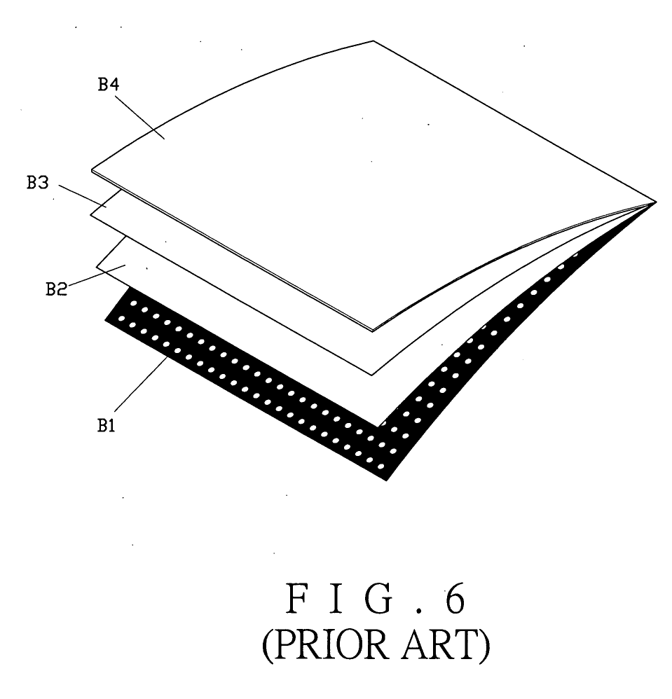

FIG. 7 is a schematic view showing another heat insulation film of the prior art.

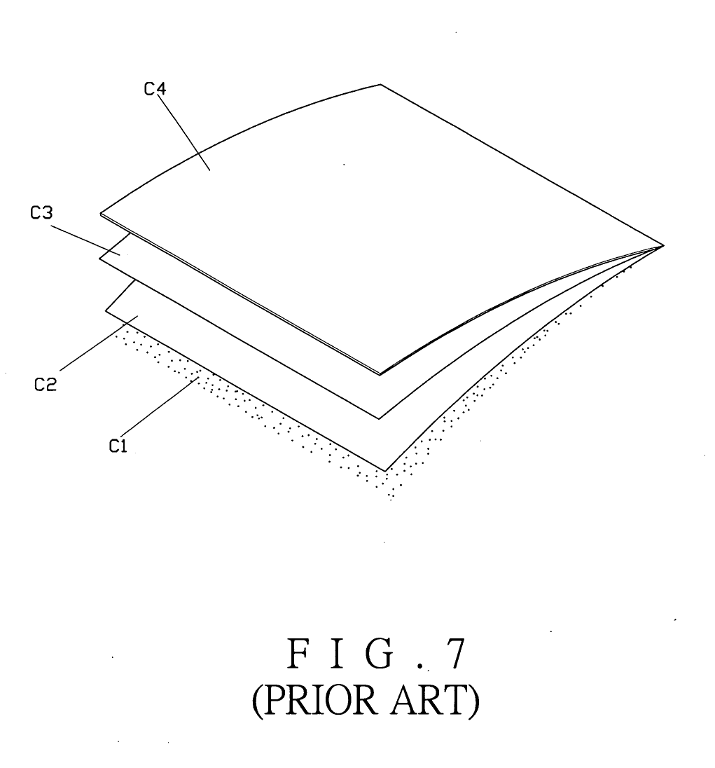

### DETAILED DESCRIPTION OF THE PREFERRED EMBODIMENTS

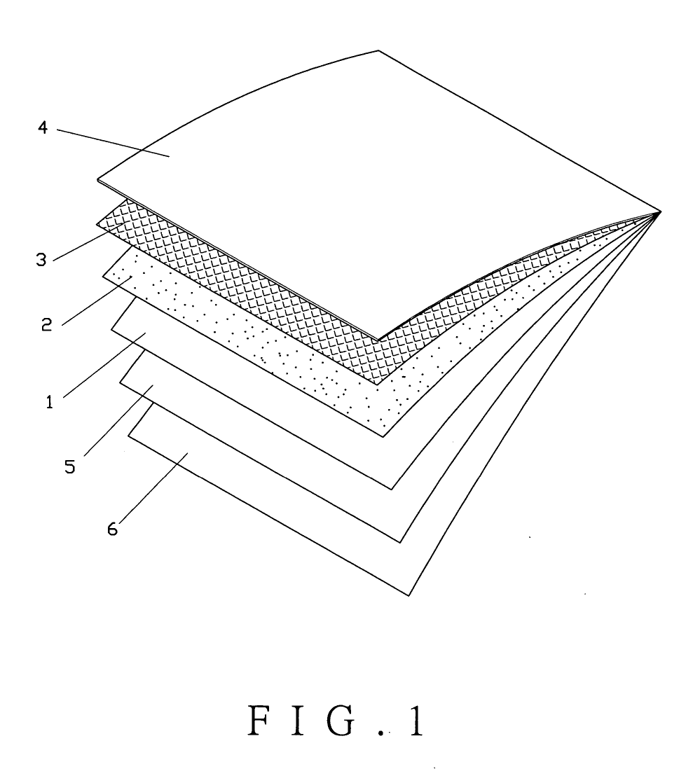

Referring to FIG. 1, the present invention includes a substrate (1), a photosensitive layer (2), a blocking layer (3), a protection layer (4), an adhesive layer (5), and a stripping layer (6). The substrate (1) includes a first surface and a second surface (not marked with numbers). The first surface is the top surface as illustrated while the second surface is the back of the first surface. The first surface of the substrate (1) is coated with the photosensitive layer (2). The photosensitive layer (2) is coated with the blocking layer (3). The blocking layer (3) is coated with the transparent protection layer (4). The second surface of the substrate (1) is coated with the adhesive layer (5). The adhesive layer (5) is coated with the stripping layer (6) to prevent the adhesive layer (5) from losing its viscosity to create a heat insulation film.

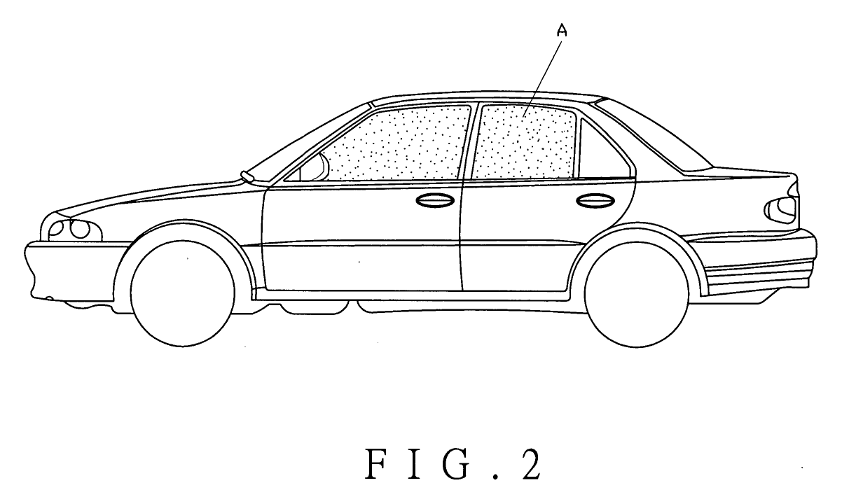

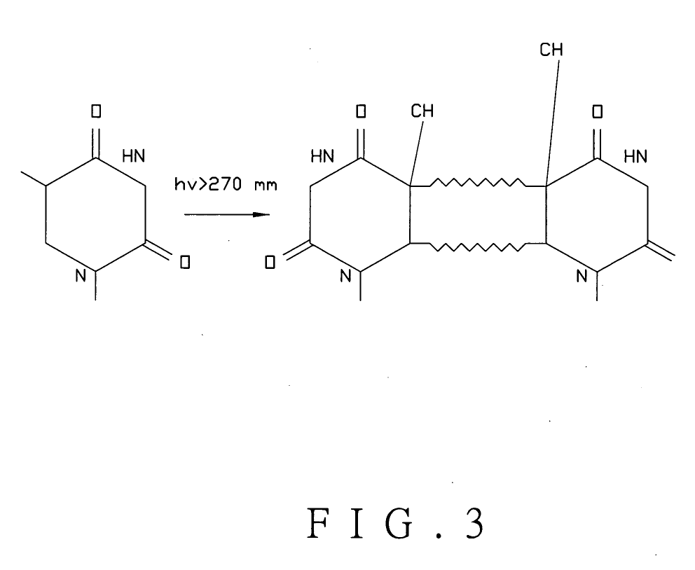

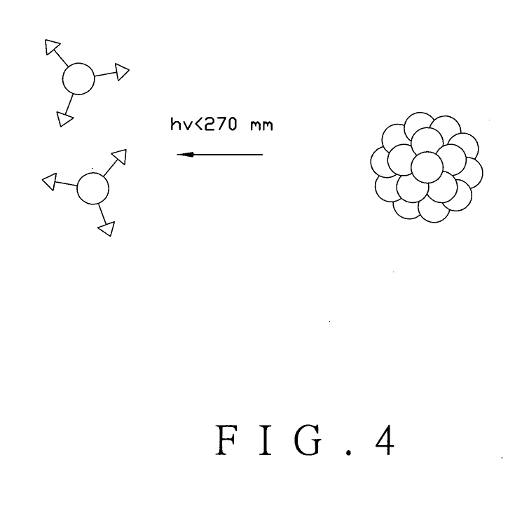

As illustrated in FIGS. 1 and 2, the present invention is applied to stick onto windows (A) of a car. The stripping layer (6) is first torn away from the adhesive layer (5) and stick to the windows (A) of the car as illustrated in FIG. 1. Once the light is permitted through the protection layer (4), energy in the light (e.g., ultraviolet, infrared, etc.) enters into the blocking layer (3) containing short-wave blocking agent with a short-wave band of 280 nm˜300 nm where the energy of the light with a wave length falling between 280 nm˜300 nm is blocked to leave only the intermediate waves sufficient for photosensitive polymer to act upon. While the light is irradiating upon the photosensitive layer (2) made of nanometer macromolecular compound as illustrated in FIG. 3, molecules in the photosensitive polymer are stimulated by the energy of the light for the nanometer molecules to indicate polymerized status, thus to reduce the light permeability for effective separation of the intermediate wave band and thermal energy. As illustrated in FIG. 4, when the molecules in the photosensitive polymer are not longer subject to the stimulation by the energy in the light, the polymerization energy for the nanometer molecules is also decreased. As a result, the polymerized status of the photosensitive polymer becomes not so tight thus to allow promoted light permeability of the substrate (1) to adjust the field of vision.

The blocking layer (3) stops the short-wave light to slow down the decay period of the photosensitive polymer thus to extend the service life of the film without affecting its sensitization brake function. Automatic dimming purpose is achieved by taking advantage of the response of the photosensitive polymer to the light to ensure of driving safety, personal privacy and property in the car during night hours, and keeping cool in the car, and separation of hazardous short-wave band of the light during daytime.

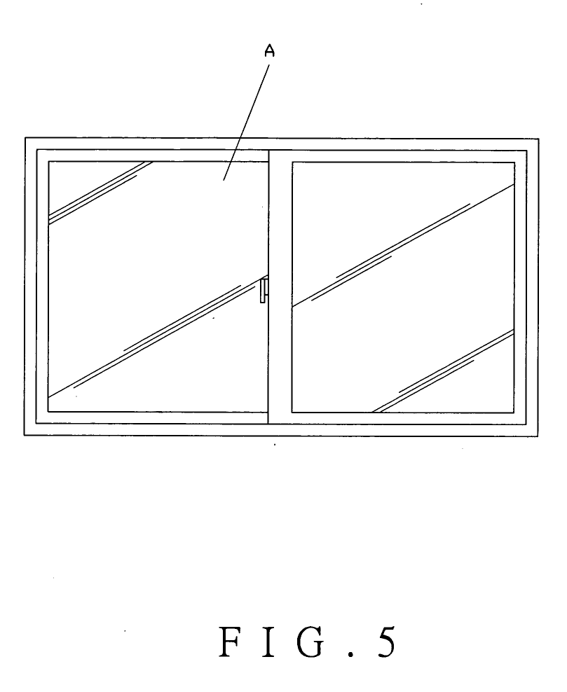

Now referring to FIGS. 1 and 5, the present invention is applied to stick on the window (A) of a home unit. Again, the stripping layer (6) is torn away from the adhesive layer (5) and stick onto the window (A) to keep the interiors of the home from any outsider, frustrate attempt by burglars, protect personal private and property, and reduce hazards from being exposed to the light of the short-wave band.

What is claimed is:

1. An automatic dimming heat insulation film comprising a substrate, a photosensitive layer, a blocking layer, a protection layer, an adhesive layer, and a stripping layer;
the substrate including a first surface and a second surface;
the photosensitive layer made of photosensitive polymer being coated on the first surface of the substrate;
the blocking layer containing short-wave blocking agent being coated on the photosensitive layer;
the protection layer being coated on the blocking layer;
the adhesive layer being coated on the second surface of the substrate; and
the stripping layer being coated on the adhesive layer.

2. The automatic dimming heat insulation film of claim 1, wherein the protection layer is transparent.

3. The automatic dimming heat insulation film of claim 1, wherein the substrate is made of polyester.
